(19) United States
(12) Patent Application Publication
(10) Pub. No.: US 2004/0175677 A1
(43) Pub. Date: Sep. 9, 2004

(54) Device and support sheet for the punctiform representation of graphical information which may be read by touch

(76) Inventors: Andreas Koch, Hannover (DE); Stefan Badur, Hannover (DE); Alexander Wilhelms, Hannover (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/478,954

(22) PCT Filed: May 31, 2002
(86) PCT No.: PCT/DE02/02003

(30) Foreign Application Priority Data
Jun. 2, 2001 (DE) 10127036.4

(51) Int. Cl. G09B 21/00

(52) U.S. Cl. 434/113

(57) ABSTRACT

The invention relates to a device for the punctiform representation of graphical information which may be read by touch, in particular for the representation of Braille script, comprising a support sheet, a number of systematically-arranged touch points and actuators for activating or deactivating selected touch points, whereby the touch points are formed such as to be integral with the support sheet. The touch points (2) have a touch region, which, in the activated state, extends above the plane formed by the touch surface of the support sheet and a flexible boundary region between the support sheet and the touch region and an erasing element is provided bring all the touch points into the activated state, or into the deactivated state, by means of a return spring action on the touch region on or below the plane formed by the touch surface on the support sheet.

The invention relates to a device and a support sheet for the punctiform representation of graphical information which can be read by touch, in particular for the representation of Braille script, with a multiplicity of systematically arranged touch points. The device has actuators for activating selected touch points, the touch points being formed integrally with the support sheet. An erasing element is provided, to bring all the touch points into the activated state or into a deactivated state by springing back of the touch region on or below the plane which is formed by the touch surface of the support sheet.

Braille characters are a punctiform script which can be read by touch for the blind, developed by Louis Braille. The characters to be represented were in this case originally coded with the aid of a system of six dots. By various arrangements of the dots, 63 combinations of the basic form can be achieved. Consequently, all the characters that can also be printed by typescript can be represented. This was followed by the development also of musical notation for the blind. To create a stenographic script for the blind, permitting a faster writing speed, the system of six dots was supplemented by a seventh dot and an eighth dot. In this way, 255 possible combinations can be represented. Consequently, every common word can be represented as a contraction. The increase in the speed compared with stenography is approximately 50%. Information on the Braille script is disclosed on the Internet at www.braille.at.

For the continuous representation of Braille characters there are known devices in which the Braille characters are created in fixed positions by parallel activation of individual fixed actuators. To permit fluent reading, very many characters (about 40 to 80 characters) must be grouped together in one or two lines. This results in a relatively large, unergonomic design and is also expensive and complex.

Devices of this type, which are known as Braille writers, represent the Braille characters on a large surface area. Further devices are known, with which the characters are represented on the outside of a large drum, for example the rotating-wheel Braille display from NIST. In the case of this Braille display, the Braille characters are represented on a rotating wheel by exposed actuators, which are provided around the entire wheel.

Modern devices for representing Braille characters have piezoelectric actuators, it being possible to represent up to 80 characters. Smaller devices with approximately 20 characters are also available. These devices or Braille writers are relatively expensive on account of their complex structural design.

There are further known devices for representing Braille script, in which a support sheet in band form circulates around two rollers that are spaced apart from one another, the Braille characters being represented on the surface of the support band.

FR 00 16 390 discloses a device in which pins are pressed into or out of the reading plane of the band by electromagnetic activation. As a result, reading of the script characters by touch is possible.

In EP 0 123 205 A1 there is a description of a method and a device for representing graphical information in Braille script, small magnetic balls which partly protrude from a support being moved into a reading plane. A suction station removes the balls that are not required. The exposed balls then represent the character to be read and can be sensed from the surface.

U.S. Pat. No. 4,571,190 likewise discloses a method in which balls are placed in a circulating band in such a way that they form letters which can be read by touch by a blind person.

The abovementioned devices are relatively large, so that mobile use is not possible, or only with difficulty. The use of steel balls also leads to a great weight and additionally hinders mobile use. Furthermore, the reading speed is not optimally variable.

DE-C 44 30 942 C1 discloses a device for displaying script for the blind in which an endlessly circulating elastic band has lugs cut into it in a U-shaped manner as character elements which can be lowered. By pressing out and positively engaging the lugs from the band, the touch points are set. Erasing the touch points takes place by stretching the band, so that the positive undercut engagement is reversed. A disadvantage is the high expenditure of force for stretching the band.

JP 02134674 A discloses a device for representing script for the blind in which a flat band with a memory function is provided. The touch points are formed such that they are raised from the band, in that pressure is exerted on the corresponding positions of the band. By heating the band, the touch points are erased again, since said band assumes a smooth surface on account of the memory function. A disadvantage is that the service life of the band [lacuna] to a restricted number of pressure/heating cycles.

In Gilliland, J. W.: Braille Character electrothermo display element. In: IBM Technical Disclosure Bulletin, Vol. 17 No. 15 Oct. 1974, pages 1481 to 1482, there is a description of a Braille reading device activatable by electrical heating, which disadvantageously does not allow running script to be created and is relatively energy-intensive and costly.

DE 34 00 094 A1 discloses a device for creating a tactile character array, in particular for representing Braille script, which has a circulating support band with a multiplicity of systematically arranged touch points. The touch points are activated by actuators. Moreover, an erasing roller is provided for the deactivation of the touch points. The touch points are dimples formed integrally with the support band, the dimples having a parabolic cross section and protruding beyond the surface of the support band in the activated state. In the deactivated state, the dimples are retracted, sprung back in a mirror-inverted manner about the plane of the support band. In an intermediate stage, the dimples are located in an undular manner in a corresponding accommodating space of the support band.

The parabolic dimples have a uniform thickness and are formed in such a way that a relatively great displacement and relatively considerable work are required to displace a dimple from one position into the other.

It was therefore an object of the invention to provide an improved device of the generic type which is inexpensive, lightweight and reliable.

The object is achieved by a device in which the touch points have a touch region, which, in the activated state, protrudes beyond the plane formed by the touch surface of the support sheet, and a flexible boundary region between the support sheet and the touch region, the boundary region having a lower thickness and/or rigidity than the support sheet and the touch region. Moreover, the touch region has an actuating portion, protruding beyond the underside of the support sheet that lies opposite from the touch surface of the support sheet.

It was also an object of the invention to provide a support sheet for the punctiform representation of graphical information in such a way that it can be read by touch.

The object is achieved by a support sheet of the generic type in which

the touch points have a touch region, which, in the activated state, protrudes beyond the plane formed by the touch surface of the support sheet, and a flexible boundary region between the support sheet and the touch region, the boundary region having a lower thickness and/or rigidity than the support sheet and/or touch region,

the touch regions are able to spring back on or below the plane which is formed by the touch surface of the support sheet, by means of the associated boundary regions, in order to bring the touch points into a deactivated state, and

the touch regions have an actuating portion, protruding beyond the underside of the support sheet that lies opposite from the touch surface of the support sheet.

The actuating portion may be realized as a pin which protrudes beyond the underside of the support sheet and is formed integrally with the touch point. In this way, activation of the touch points can take place in a very energy-saving manner by simple actuators.

Consequently, according to the invention, a support layer in sheet form is provided, in which the systematically arranged touch points for representing Braille script are formed integrally into the support sheet in such a way that the touch points assume a raised activated state and a lowered deactivated state, or a state in which they terminate with the touch surface of the support sheet, it being possible for the touch points to be brought from one state into the other state in a resilient manner by means of the thinner or more flexible boundary regions.

This has the advantage that no additional mechanical wearing parts are required and the device with the support sheet can be constructed in a relatively lightweight and small form. The fact that the touch points are formed integrally with the support sheet has the effect that the support sheet can be easily cleaned and is protected against soiling. The individual Braille dots are hermetically sealed, so that no dirt can get in. Moreover, only a low level of mechanical complexity and a low energy demand are required, so that the device can be used in battery operation.

The thickening according to the invention in the central region of the touch point in the form of a touch region which is held in the support sheet by a thinner resilient bead (flexible boundary region) has the effect that only short pulses and little work is required to bring the touch points from a deactivated state into an activated state. This has the advantage that the energy demand is lower in comparison with conventional Braille reading devices and smaller actuators can be used. The device according to the invention is therefore suitable for mobile applications.

The actuating portion protruding below the underside of the support sheet, for example in the form of a pin, allows the actuators to be given a simple form, for example resiliently mounted rollers.

The device has actuators to activate selected touch points, in that they are pressed out from the support sheet in such a way that they protrude beyond the plane formed by the touch surface of the support sheet. Furthermore, an erasing element is provided, in order to bring all the touch points into a deactivated state by springing back of the corresponding touch regions on or below the plane which is formed by the touch surface of the support sheet. Alternatively, the erasing element may also be formed to bring all the touch points into the activated state. The Braille characters are represented with the aid of the actuators, in that selected activated touch points are deactivated by the corresponding touch regions springing back on or below the plane which is formed by the touch surface of the support sheet.

The touch points preferably have an unsymmetrical force distribution in such a way that it is more difficult for the touch points to be pressed from the activated state into the deactivated state than vice versa. In the activated state, the touch points are consequently more difficult to press in, whereas they can easily be pressed out from the deactivated state into the activated state. This unsymmetrical force distribution can be achieved for example by shaping. For this purpose, the spring rigidity may be adapted, in that for example a membrane spring is realized in the bead by a highly arched shape of the touch points. The edges of the touch points, i.e. the outer boundaries of the boundary region, should be shaped in such a way that they are folded in the deactivated state and are parabolically arched in the activated state. In this way, the activated state is given priority.

For each Braille character, the touch points are, for example, arranged in two lines with four points in each case, in order to represent a Braille character comprising a maximum of eight dots. The spacing between the points is in this case approximately 2.4 mm.

The support sheet is preferably formed with a plastic and preferably consists of polyurethane. The support sheet may have a flexible, fiber-reinforced layer. The support sheet preferably has wedge-shaped tapers between the touch regions, in order to achieve improved flexibility and consequently facilitated bending over and deflection by hinge-like behavior of the tapers. The touch points can consequently be automatically activated or deactivated by passing over a roller. Teeth for transporting the band can engage in the wedge-shaped tapers.

It is particularly advantageous if the support sheet is a continuous band which can be clamped in a circulating manner between two deflecting rollers that are spaced apart from one another. In this way, the graphical information can be continuously represented as running script. It is advantageous for this if tooth flanks on the support sheet are provided for engagement in driving rollers. The touch points should then be respectively arranged in the regions between the tooth flanks.

In another embodiment, the support sheet is formed as a disk-shaped turntable, which is preferably rotated by a motor in the center of the turntable.

The activation of the membranes may take place mechanically or magnetically, but also thermally and piezoelectrically.

In the embodiment of the support sheet as a continuous band which is clamped in a circulating manner between two deflecting rollers that are spaced apart from one another, the band is turned continuously or discontinuously, so that a running script is created. For this purpose, the Braille characters are represented in the support sheet at the beginning of the circulating path with the aid of actuators acting on the touch points. After completion of the circulation, the Braille characters are then erased again by an erasing element. This preferably takes place by an erasing drum acting against the circulating roller at the end of the circulating path, the raised touch points being pressed by the erasing drum below the plane formed by the surface of the support sheet.

In the case of another advantageous embodiment, it is provided that a multiplicity of continuous bands are respectively clamped in a circulating manner between two deflecting rollers that are spaced apart from one another. The axes of the deflecting rollers are in line with one another, so that the continuous bands extend parallel to one another. For each band, a character or a column of characters is represented in this way. The bands arranged in parallel next to one another form a line with Braille characters. Circulating of the bands running transversely in relation to the line has the effect that the Braille characters of a line are continued independently of one another. Approximately synchronous turning of the support sheets accomplishes a complete change of characters.

It is particularly advantageous if a sensor for sensing the reading speed and a regulating unit for regulating the speed of the representation of continuous information are provided. In this way, the speed of movement of the at least one support sheet can be variably adapted to the reading speed of the reader. The sensor is preferably a pressure sensor, so that the reading speed is controlled by the touching pressure of the fingers on the support sheet.

It is particularly advantageous if the device has an additional voice output unit for acoustic output of the information. The graphically and acoustically representable information may in this case be transmitted in a coded form, for example in the Wave or MP3 format.

Furthermore, it is advantageous if the device has an interface for the transmission of the information from a terminal unit, such as for example a computer, to the device. The interface should be formed in particular for radio transmission or infrared transmission. In the case of radio transmission, the information can be transmitted from the terminal unit for example on the basis of the Bluetooth standard. The interface may, however, also be an SCSI interface, a parallel interface, a serial interface, a USB interface or PS/2 interface, etc.

The invention is explained in more detail below on the basis of the accompanying drawings, in which:

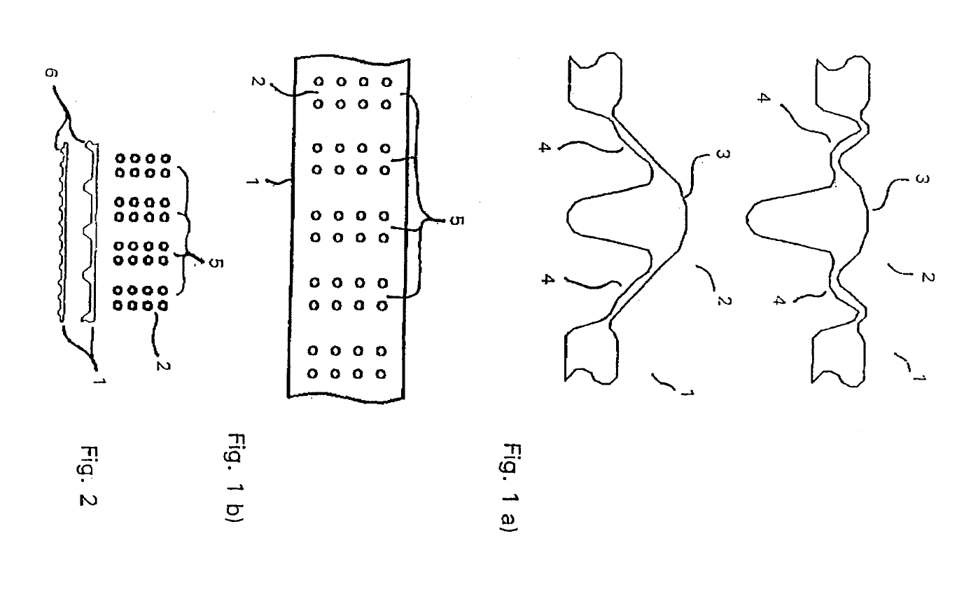

FIG. 1 shows a cross-sectional view of a detail of the support sheet with a touch point;

FIG. 2 shows a plan view of a support sheet in band form with systematically arranged touch points and a cross-sectional view of the support sheet with tooth flanks;

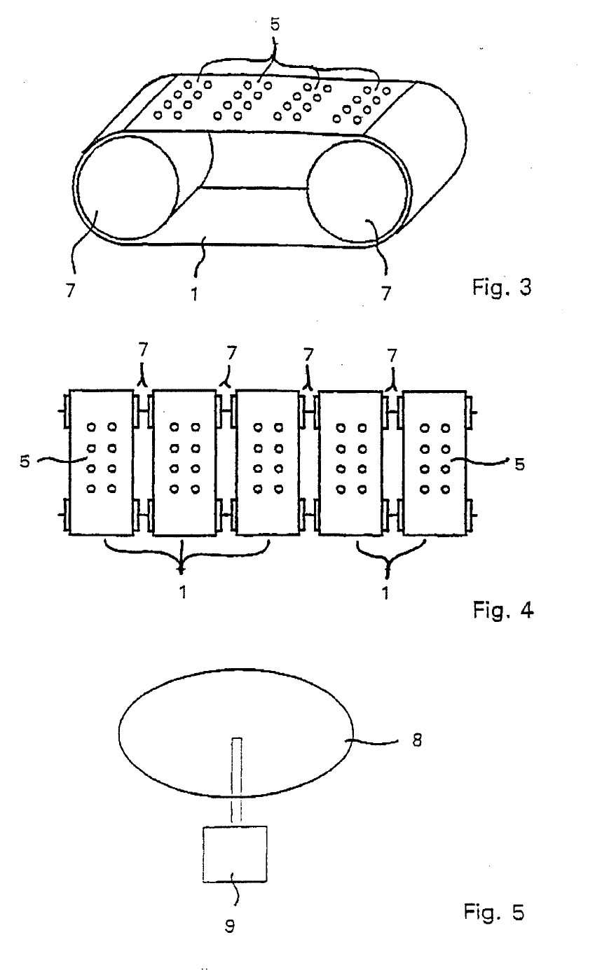

FIG. 3 shows a device for the representation of Braille script with a circulating support band;

FIG. 4 shows a device for the representation of Braille script with a number of continuous bands running in parallel next to one another;

FIG. 5 shows a device for the representation of Braille script with a plate in disk form as a support sheet;

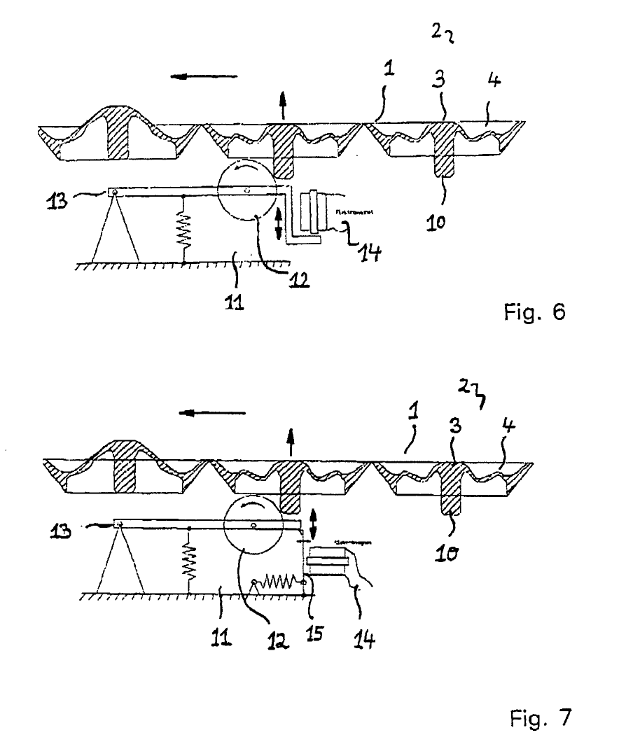

FIG. 6 shows a cross-sectional view of a support sheet with an electromagnetically activated roller actuator arranged underneath it;

FIG. 7 shows a cross-sectional view of a support sheet with a second embodiment of an electromagnetically activated roller actuator.

FIG. 1 shows a support sheet 1 with a touch point 2, which is formed integrally with the support sheet 1. The support sheet 1 has at least one touch region 3, which, drawn as a continuous line, in the activated state protrudes beyond the plane formed by the touch surface of the support sheet 1. Provided between the touch region 3 and the support sheet 1 is an undular flexible boundary region 4, to make it possible that the touch region 3 can be pressed by a suitable actuator into an active state, in which the excess material of the support sheet 1 forming the touch region 3 protrudes beyond the plane formed by the surface of the support sheet 1. The flexible boundary region 4 allows the touch region 3 to continue to be sprung back into a deactivated state, in which the touch region lies below 3 the plane [sic], which is defined by the touch surface of the support sheet 1.

The touch points 2 may advantageously be produced by the flexible boundary region 4 of the support sheet 1 formed from plastic being heated for a short time. The touch region 3 is preferably formed in a dome-shaped manner by heating.

FIG. 2 shows a plan view of the support sheet 1 with a systematic arrangement of the touch points 2, a group 5 of eight touch points 2 respectively forming a character and four lines with two touch points 2 lying directly next to one another being provided.

Other distributions of the touch points 2 are possible, however, in order for example to make larger graphical representations not only able to be read by touch but also able to be seen.

FIG. 2 also shows two embodiments of the support sheet 1 in cross section. It is clear that tooth flanks 6 which engage in driving or deflecting rollers (not represented) are arranged on the underside of the support sheet 1, so that the support sheet 1 can be advanced. The support sheet 1 is in this case formed as a circulating band.

This embodiment is sketched in FIG. 3 as a perspective view. It is clear that the circulating support sheet 1 in band form is clamped between two deflecting rollers 7 that are spaced apart from one another. The information to be read by touch is represented and read by touch on the surface of the support sheet 1. The actuators for the activation or deactivation of the touch points 2 may be arranged for example in the lower portion of the support sheet 1. The deflecting rollers 7 may be formed in such a way that they serve at the same time as erasing rollers and press out the touch points 2 into the activated state [sic] when the support sheet 1 is rolled over a deflecting roller 7.

At least one of the deflecting rollers 7 is driven by a motor and thereby provides the circulation of the support sheet 1 in band form.

FIG. 4 shows a further embodiment of the device according to the invention, in which a number of support sheets 1 are respectively clamped in a circulating manner between two deflecting rollers 7 that are spaced apart from one another. The support sheets 1 in band form are aligned in such a way that they extend parallel to one another. For this purpose, the axes of the deflecting rollers 7 are in line with one another.

In the embodiment according to FIGS. 2 and 3, a line is represented on the support sheet 1 in band form, so that the line can be continuously displaced.

As a difference from this, in the embodiment according to FIG. 4, a character or a column of characters is represented by each support sheet 1 in band form and a reading line is defined by the multiplicity of support sheets 1 in band form arranged next to one another. The circulating direction of the support sheets 1 in band form is in this case transverse to the direction of the line.

FIG. 5 shows a further embodiment of the device. The support sheet 1 is in this case formed as a disk-shaped turntable 8, which is rotated by a driving unit 9, which acts on the center axis of the turntable 8. The touch points 2 are arranged on the surface of the disk-shaped turntable 8 and can likewise be activated by actuators.

FIG. 6 shows a schematic cross-sectional view of a support sheet 1 with touch points 2, which have according to the invention touch regions 3 in the form of a thickening in the central region of the touch point 2, the touch regions 3 being held in the support sheet 1 by a thinner resilient bead in the form of a flexible boundary region 4. Provided underneath the support sheet 1 is a roller actuator 11, which substantially comprises a roller 12 which is carried by a rocker 13 mounted in a resiliently tiltable manner. The actuating portions 10 in this case run over the roller 12 and are pressed upward by the latter, so that the touch points 2 are brought into the activated state when the rocker 13 holds the roller directly underneath the support sheet 1. This position can be fixed with the aid of an electromagnet 14, which serves for the activation or deactivation of the rocker 13, and consequently of the roller actuator 11.

Provided between the touch points 2, in the transverse direction in the manner of a link chain, are wedge-shaped tapers, so that improved flexibility is attained and facilitated deflection is achieved by a hinge-like behavior of the tapers.

FIG. 7 likewise shows a support sheet 1 in cross section, in which however a different embodiment of a roller actuator 11 is provided. A roller 12 is in turn supported by a tiltable, resilient rocker 13 and serves for pressing the actuating portions 10 upward, in order to bring the touch points 2 into an activated state. In the case of this embodiment of the roller actuator 11, provided at the free end of the tilting rocker 13, and running transversely in relation to it, is a pivotably mounted blocking element 15, which is likewise preloaded with the aid of a spring, so that the blocking element 15 is drawn into the blocking state. Provided in turn is an electromagnet 14, with which however the blocking element 15 can be pivoted from the contact position with the rocker 13 into a release position. The roller 12 is then pressed downward by the actuating portion 10 without it being possible for a force to be exerted by the roller actuator 11 to press the actuating portion 10 upward, for its part, in order to bring the touch points 2 into the activated state.

In order that an optimum reading speed can be maintained, an optical sensor is preferably provided in the devices described above for adapting the speed to the reading speed. In one embodiment, a pressure sensor which regulates the speed in dependence on the pressure exerted on the support sheet during reading by touch may also be provided.

1. A device for the punctiform representation of graphical information which can be read by touch, in particular for the representation of Braille script, with a support sheet (1), with a multiplicity of systematically arranged touch points (2) and with actuators for activating or deactivating selected touch points (2), the touch points (2) being formed integrally with the support sheet (1), and an erasing element being provided, to bring all the touch points (2) into the activated state or into a deactivated state by springing back of the touch region (3) on or below the plane which is formed by the touch surface of the support sheet (1), characterized in that
the touch points (2) have a touch region (3), which, in the activated state, protrudes beyond the plane formed by the touch surface of the support sheet (2), and a flexible boundary region (4) between the support sheet (1) and the touch region (3), the boundary region (4) having a lower thickness and/or rigidity than the support sheet (1) and the touch region (3), and
the touch region (3) has an actuating portion, protruding beyond the underside of the support sheet (1) that lies opposite from the touch surface of the support sheet (1).

2. The device as claimed in claim 1, characterized in that the support sheet (1) is formed with a plastic.

3. The device as claimed in claim 2, characterized in that the plastic is polyurethane.

4. The device as claimed in one of claims 1 to 3, characterized in that the support sheet (1) has a flexible, fiber-reinforced layer.

5. The device as claimed in one of claims 1 to 4, characterized in that the support sheet (1) is a continuous band.

6. The device as claimed in claim 5, characterized by a driving unit with at least one deflecting roller (7) and with tooth flanks (6) or tapers on the support sheet (1) for engagement in the at least one deflecting roller (7).

7. The device as claimed in claim 6, characterized in that the touch points (2) are respectively arranged in the regions between the tooth flanks (6) or tapers.

8. The device as claimed in one of claims 1 to 7, characterized in that the support sheet (1) is clamped as a continuous band in a circulating manner between two deflecting rollers (7) that are spaced apart from one another.

9. The device as claimed in one of claims 1 to 7, characterized in that a multiplicity of support sheets (7) are clamped as continuous bands in a circulating manner respectively between two deflecting rollers (7) that are spaced apart from one another, the axes of the deflecting rollers (7) being in line with one another and the continuous bands extending parallel to one another.

10. The device as claimed in one of claims 1 to 9, characterized in that the at least one actuator is formed for the mechanical, magnetic, piezoelectric or thermal activation of the touch points (2).

11. The device as claimed in one of claims 1 to 4, characterized in that the support band (1) is formed as a disk-shaped turntable (8).

12. The device as claimed in one of the preceding claims 1 to 11, characterized by a sensor for sensing the reading speed and a regulating unit for regulating the speed of the representation of continuous information.

13. The device as claimed in claim 12, characterized in that the sensor is a pressure sensor.

14. The device as claimed in one of the preceding claims 1 to 13, characterized by a voice output unit for the acoustic output of the information.

15. The device as claimed in one of claims 1 to 14, characterized by an interface for the transmission of the information from a terminal unit to the device.

16. The device as claimed in claim 15, characterized in that the interface is formed for radio transmission or infrared transmission.

17. The device as claimed in one of the preceding claims, characterized in that the touch points (2) have an unsymmetrical force distribution, so that it is more difficult for the touch points (2) to be pressed from the activated state into the deactivated state than vice versa.

18. A support sheet (1) for the punctiform representation of graphical information which can be read by touch, in particular for the representation of Braille script, with a multiplicity of systematically arranged touch points (2), the touch points (2) being formed integrally with the support sheet (1), characterized in that
the touch points (2) have a touch region (3), which, in the activated state of the touch points (2), protrudes beyond the plane formed by the touch surface of the support sheet (2), and a flexible boundary region (4) between the support sheet (1) and the touch region (3), the boundary region (4) having a lower thickness and/or rigidity than the support sheet (1) and the touch region (3),
the touch regions (3) are able to spring back and [sic] or below the plane which is formed by the touch surface of the support sheet (1), by means of the associated boundary regions (4), in order to bring the touch points (2) into a deactivated state, and
the touch regions (3) have an actuating portion, protruding beyond the underside of the support sheet (1) that lies opposite from the touch surface of the support sheet (1).

19. The support sheet (1) as claimed in claim 18, characterized in that the support sheet (1) is formed with a plastic.

20. The support sheet (1) as claimed in claim 19, characterized in that the plastic is polyurethane.

21. The support sheet (1) as claimed in one of claims 18 to 20, characterized in that the support sheet (1) has a flexible, fiber-reinforced layer.

22. The support sheet (1) as claimed in one of claims 18 to 21, characterized in that the support sheet (1) is a continuous band.

23. The support sheet (1) as claimed in claim 22, characterized by tooth flanks (6) or tapers on the support sheet for engagement in deflecting rollers (7).

24. The support sheet (1) as claimed in claim 23, characterized in that the touch points (2) are respectively arranged in the regions between the tooth flanks (6) or tapers.

25. The support sheet (1) as claimed in one of claims 18 to 21, characterized in that the support sheet (1) is formed as a disk-shaped turntable (8).

26. The support sheet (1) as claimed in one of claims 18 to 25, characterized in that the touch points (2) are thermally activatable.

27. The support sheet (1) as claimed in one of claims 18 to 26, characterized in that the touch points (2) have an unsymmetrical force distribution, so that it is more difficult for the touch points (2) to be pressed from the activated state into the deactivated state than vice versa.

28. A method for producing a support sheet (1) as claimed in one of claims 18 to 27, characterized by heating the boundary region (4) for transforming the material of the support sheet (1) in the boundary region (4) into a flexible state.
